(19) United States
(12) Patent Application Publication
(10) Pub. No.: US 2021/0142227 A1
(43) Pub. Date: May 13, 2021

(54) METHOD AND SYSTEM FOR UPGRADING SEAT TICKETS

(71) Applicant: Dibbzz Inc., London (CA)

(72) Inventor: Brennon D'SOUZA, London (CA)

(73) Assignee: Dibbzz Inc., London, ON (CA)

(21) Appl. No.: 16/629,794

(22) PCT Filed: Jul. 12, 2018
(86) PCT No.: PCT/CA2018/050851

§ 371 Date: Jan. 9, 2020

Related U.S. Application Data
(60) Provisional application No. 62/531,618, filed on Jul. 12, 2017.

(51) Int. Cl. G06Q 10/02; G06Q 20/32; H04W 4/14; H04W 84/02; G06F 16/9035

(52) U.S. Cl. CPC G06Q 10/02; G06Q 20/3255; G06F 16/9035; H04W 84/02; H04W 4/14

(57) ABSTRACT

Systems and methods for upgrading a seat of at least one ticket using short message service (SMS) or multimedia messaging service (MMS) are described herein. Existing seat information is received from a portable computing device. The existing seat information is transmitted over a cellular network from the portable computing device by SMS or MMS. Available seat information is obtained. At least one seat upgrade option is determined and provided to the portable computing device over the cellular network by SMS or MMS. Payment is received and the seat upgrade is provided to the portable computing device over the cellular network by SMS or MMS.

### CROSS-REFERENCE TO RELATED APPLICATIONS

The present application claims priority to U.S. Provisional Patent Application bearing Ser. No. 62/531,618 filed on Jul. 12, 2017, the contents of which are hereby incorporated by reference.

### TECHNICAL FIELD

The present disclosure relates generally to computer-implemented methods and systems for providing tickets, and, more particularly, to computer-implemented methods and systems for upgrading tickets.

### INTRODUCTION

Some seats for events at venues (e.g., stadiums, theaters, performing arts centers, concert halls, etc.) regularly go unsold, which may result in the venues losing out on revenue. Upgrading seats at some venues may require visiting a box office to inquire as to whether upgrading is possible, which may be time consuming and inconvenient.

Existing computer-implemented ticketing systems allow for users to purchase tickets online for an event prior to attending the event. For example, a user may visit a website associated with a ticketing system to purchase a ticket prior to attending the event. Once the user has entered the event with the purchased ticket, if the user would like a better seat or is unsatisfied with his/her current seat, the user is typically unable to use the online ticketing system to upgrade his/her ticket.

As such, there is a need for systems and methods for seat ticket upgrading.

### SUMMARY

Computer-implemented methods and systems are described herein that allow for a portable computing device to be used to upgrade a user's seat ticket(s) through short message service (SMS) and/or multimedia messaging service (MMS) while the user is at an event at a venue.

According to an aspect, there is provided a computer-implemented method for upgrading at least one ticket. The method comprises: receiving existing seat information from a portable computing device, the existing seat information being transmitted over a cellular network from the portable computing device by short message service or multimedia messaging service; obtaining available seat information; processing, with at least one processing unit, the existing seat information and the available seat information to determine at least one seat upgrade option; providing the at least one seat upgrade option to the portable computing device, the at least one seat upgrade option being transmitted over the cellular network to the portable computing device by short message service or multimedia messaging service; receiving a selected seat upgrade from the portable computing device, the selected seat upgrade being transmitted over the cellular network from the portable computing device by short message service or multimedia messaging service; in response to receive the selected seat upgrade, providing a payment mechanism to the portable computing device, the payment mechanism being transmitted over the cellular network to the portable computing device by short message service or multimedia messaging service; and in response to receiving payment, providing a confirmation for the selected seat upgrade to the portable computing device, the confirmation for the selected seat upgrade being transmitted over the cellular network to the portable computing device by short message service or multimedia messaging service.

In some embodiments, receiving the existing seat information from the portable computing device comprises receiving the existing seat information from a messaging hub configured for receiving the existing seat information transmitted from the portable computing device by short message service or multimedia messaging service.

In some embodiments, providing the at least one seat upgrade option to the portable computing device comprises providing the at least one seat upgrade option to the messaging hub configured for providing the at least one seat upgrade option to the portable computing device by short message service or multimedia messaging service.

In some embodiments, receiving the selected seat upgrade from the portable computing device comprises receiving the selected seat upgrade from the messaging hub configured for receiving the selected seat upgrade transmitted from the portable computing device by short message service or multimedia messaging service.

In some embodiments, providing the payment mechanism to the portable computing device comprises providing the payment mechanism to the messaging hub configured for providing the payment mechanism to the portable computing device by short message service or multimedia messaging service.

In some embodiments, providing the confirmation for the selected seat upgrade to the portable computing device comprises providing the confirmation for the selected seat upgrade to the messaging hub configured for providing the confirmation for the selected seat upgrade to the portable computing device by short message service or multimedia messaging service.

In some embodiments, the existing seat information is text indicating at least one seat number.

In some embodiments, the existing seat information is an image indicating at least one seat number.

In some embodiments, obtaining available seat information comprises obtaining the available seat information from a database storing the available seat information.

In some embodiments, obtaining available seat information comprises obtaining the available seat information from a venue ticketing system over a data network.

In some embodiments, obtaining the available seat information from the venue ticketing system comprises: transmitting a first request to the venue ticketing system, the first request for requesting purchaser information associated with the existing seat information; receiving a first response from the venue ticketing system with the purchaser information; processing the purchaser information to determine a criteria for requesting the available seat information; transmitting a second request to the venue ticketing system, the second request for requesting the available seat information that meets the criteria; and receiving a second response comprising the available seat information meeting the criteria from the venue ticketing system.

In some embodiments, the method further comprises transmitting a seat hold request to the venue ticketing system over the data network prior to providing the at least one seat upgrade option to the portable computing device, the seat hold request requesting that the venue ticketing system hold at least one seat corresponding to the at least one seat upgrade option.

In some embodiments, the method further comprises transmitting a seat purchase request to the ticketing system over the data network in response to receiving the payment, the seat purchase request indicating that at least one seat corresponding to the selected seat upgrade is to be purchased by the user.

In some embodiments, the method further comprises transmitting a seat release request to the ticketing system over the data network in response to receiving the payment, the seat release request indicating that at least one seat corresponding to the existing seat information is eligible for resale.

In some embodiments, the payment mechanism comprises a link to a third-party payment process for providing payment.

According to another aspect, there is provided a system for upgrading at least one ticket. The system comprises: at least one processing unit; and a non-transitory computer-readable memory having stored thereon program instructions executable by the at least one processing unit for: receiving existing seat information from a portable computing device, the existing seat information being transmitted over a cellular network from the portable computing device by short message service or multimedia messaging service; obtaining available seat information from a venue ticketing system over a data network; processing the existing seat information and the available seat information to determine at least one seat upgrade option; providing the at least one seat upgrade option to the portable computing device, the at least one seat upgrade option being transmitted over the cellular network to the portable computing device by short message service or multimedia messaging service; receiving a selected seat upgrade from the portable computing device, the selected seat upgrade being transmitted over the cellular network from the portable computing device by short message service or multimedia messaging service; in response to receive the selected seat upgrade, providing a payment mechanism to the portable computing device, the payment mechanism being transmitted over the cellular network to the portable computing device by short message service or multimedia messaging service; and in response to receiving payment, providing a confirmation for the selected seat upgrade to the portable computing device, the confirmation for the selected seat upgrade being transmitted over the cellular network to the portable computing device by short message service or multimedia messaging service.

In some embodiments, the program instructions are further executable by the at least one processing unit for transmitting a seat hold request to the venue ticketing system over the data network prior to providing the at least one seat upgrade option to the portable computing device, the seat hold request requesting that the venue ticketing system hold at least one seat corresponding to the at least one seat upgrade option.

In some embodiments, the program instructions are further executable by the at least one processing unit for transmitting a seat purchase request to the ticketing system over the data network in response to receiving the payment, the seat purchase request indicating that at least one seat corresponding to the selected seat upgrade is to be purchased by the user.

In some embodiments, the program instructions are further executable by the at least one processing unit for transmitting a seat release request to the ticketing system over the data network in response to receiving the payment, the seat release request indicating that at least one seat corresponding to the existing seat information is eligible for resale.

According to a broad aspect, there is provided a method for upgrading a seat of at least one ticket, the method comprising: receiving, from a portable computing device, existing seat information; obtaining, from a venue ticketing system, available seat information; determining, from the existing seat information and the available seat information, at least one seat upgrade option; providing, to the portable computing device, the at least one seat upgrade option; in response to receive from the portable computing device a selected seat upgrade, providing the portable computing device with a mechanism to provide payment; and in response to receiving payment, providing the portable computing device with confirmation for the selected seat upgrade.

### DESCRIPTION OF THE DRAWINGS

Reference is now made to the accompanying figures in which:

FIG. 1A is a block diagram of a system for upgrading seats, in accordance with an embodiment;

FIG. 1B is a block diagram of the system of FIG. 1A, in accordance with specific and non-limiting example of implementation;

FIG. 2 is a flowchart illustrating an example method for upgrading a seat of at least one ticket, in accordance with an embodiment;

FIG. 3A is a graphical representation of a screen of a portable computing device illustrating upgrading of a seat, in accordance with an embodiment;

FIG. 3B is a signal diagram illustrating communication between a seat upgrading system and a portable computing device via a messaging hub, in accordance with an embodiment;

FIG. 3C is a signal diagram illustrating application programming interface (API) requests and replies between a seat upgrading system and a venue ticketing system, in accordance with an embodiment;

FIG. 3D is a graphical representation of datasets corresponding to available seat information and to seat upgrade options, in accordance with specific and non-limiting example; and

FIG. 4 is a schematic diagram of an example computing system for implementing the method of FIG. 2 in accordance with an embodiment.

It will be noted that throughout the appended drawings, like features are identified by like reference numerals.

### DETAILED DESCRIPTION

FIG. 1A illustrates a block diagram of an example system 100 for upgrading seat tickets. As shown, a seat upgrading system 120 is configured to communicate with a venue ticketing system 130 and a computing device 110.

The venue ticketing system 130 may be any suitable computer-based ticketing system comprising one or more databases having information relating to tickets available for one or more events at one or more venues. The venue ticketing system 130 is implemented using one or more computing devices (e.g., one or more servers). For example, the venue ticketing system 130 may comprise one or more of the Ticketmaster™ system, the tickets.com™ system, etc. Other types of venue ticketing system are also contemplated. The venue ticketing system 130 provides an application programming interface (API). The API is configured to allow the seat upgrading system 120 to query the venue ticketing system 130, for example, to obtain seat information for an event at a venue, to hold and/or purchase ticket(s) for an event at a venue, and/or the like.

The seat upgrading system 120 is implemented using one or more computing devices. For example, the seat upgrading system 120 may be one or more servers. The seat upgrading system 120 is configured to communicate with the venue ticketing system 130. For example, the seat upgrading system 120 is configured to query the venue ticketing system 130 using the API provided by the venue ticketing system 130. The seat upgrading system 120 may communicate with the venue ticketing system 130 to obtain available seat information for an event at a venue to hold and/or purchase ticket(s) for an event at a venue, and/or the like. The seat upgrading system 120 is configured to communicate with the computing device 110 using short message service (SMS) and/or multimedia messaging service (MMS).

With SMS, the user may send a message of up to 160 characters. Longer SMS messages may automatically be split up into several parts. The term “text message” originally referred to messages sent using SMS; however, it has grown beyond alphanumeric text to include MMS containing digital images, videos, sound content, and/or ideograms (also known as emoji). MMS is a standard way to send messages that include multimedia content. The MMS standard extends the core SMS capability, allowing the exchange of text messages greater than 160 characters in length. The term “text message” as used herein refers to a SMS and/or MMS message.

The computing device 110 may be any portable computing device such as a mobile phone, tablet and/or any other suitable computing device. The computing device 110 may be associated with a user. The user may be an existing ticket holder for the event at the venue looking to possibly upgrade his/her seat location while at the event. The computing device 110 is configured to communicate with the seat upgrading system 120 using SMS and/or MMS to upgrade the user's seat(s).

With additional reference to FIG. 1B, the example system 100 is further illustrated in accordance with specific and non-limiting example of implementation. The seat upgrading system 120 is configured to communicate with the computing device 110 through SMS and/or MMS via a cellular network 140. The text message transmitted by the computing device 110 may be received at a messaging hub 160 from the cellular network 140. The messaging hub 160 is configured to provide SMS and/or MMS message relaying services for sending and receiving SMS and/or MSS messages. The messaging hub 160 may be implemented using one or more computing devices (e.g., one or more servers). For example, the messaging hub 160 may be the two-way SMS/MMS messaging service provided by Infobip™, Twilio™, or any other suitable provider. The messaging hub 160 is configured to receive the text messages from the cellular network 140. In some embodiments, the messaging hub 160 may receive the text messages from the cellular network 140 over a data network 150. The data network 150 may be one or more of a personal area network (PAN), a local area network (LAN), a metropolitan area network (MAN), a wide area network (WAN), a cellular network, the Internet and/or any other suitable network. While only a single data network 150 is illustrated, it is understood that more than one data network may be used. The messaging hub 160 is configured to forward the text messages by providing the information comprised in the text messages to the seat upgrading system 120, for example over the data network 150. The messaging hub 160 is configured to send text messages based on information provided from the seat upgrading system 120, for example over the data network 150. The messaging hub 160 may provide an API that allows the seat upgrading system 120 to receive text messages from the computing device 110 and send text messages to the computing device 110.

In accordance with an embodiment, the seat upgrading system 120 is configured to communicate with the venue ticketing system 130 through the data network 150. For example, the seat upgrading system 120 may transmit an API request to the venue ticketing system 130 over the data network 150 and receive the an API response from the venue ticketing system 130 over the data network 150.

In accordance with an embodiment, a payment processor system 170 provides third-party payment service that allows payment to be made by a user associated with the computing device 110 to the seat upgrading system 120 over the data network 150. The payment processor system 170 may comprise one or more computing devices (e.g., one or more servers). The payment processor system 170 may allow for the user associated with the computing device 110 to provide payment, for example by credit or debit card, to the seat upgrading system 120. The payment processor system 170 may be any third-party payment processor, for example, such as Interact™, PayPal™, Apple Pay™, Google Wallet™ and/or any other third-party payment processor.

With reference to FIG. 2, there is shown a flowchart illustrating an example method 200 for upgrading a seat of at least one ticket. In accordance with an embodiment, the method 200 is implemented by the seat upgrading system 120.

At 202, existing seat information is receiving from the portable computing device 110. In accordance with an embodiment, the existing seat information is transmitted over the cellular network 140 from the portable computing device 110 by SMS or MMS. The existing seat information is indicative of the seat number(s) of the user associated with the portable computing device 110. The existing seat information may comprise one or more seat numbers associated with the user of the portable computing device 110. The existing seat information may comprise a single seat number or may comprise more than one seat number (e.g., 2 seat numbers, 3 seat numbers, 4 seat numbers, etc.). The existing seat information may comprise text or an image indicative of the seat number(s). The existing seat information may comprise one or more electronic tickets. The existing seat information may comprise a barcode(s) or QR code(s). The existing seat information may comprise a photograph of the ticket(s) and/or the barcode(s) or QR code(s) from the ticket(s). The existing seat information may comprise a ticket purchase confirmation number and/or any other suitable identifier indicative of the seat number(s).

By way of example, when the user enters the venue, the user may see a sign, poster, projection, electronic display or the like, displaying a telephone number and instructions to send a text message to the telephone number with the user's existing seat information, if the user is interested in upgrading his/her seat location. In some embodiments, the instructions for upgrading seats may be on the ticket. The user may then send a first text message to the displayed telephone number provided along with the existing seat information.

At 204, available seat information is obtained. The available seat information may be obtained from the venue ticketing system 130 over the data network 150. The available seat information may be obtained from a database of the seat upgrading system 120. The available seat information may include information indicating available unsold seats for the event at the venue. The available seat information may also comprise the cost associated with each seat. The venue ticketing system 130 and/or the seat upgrading system 120 may access one or more databases to obtain the available seat information.

At 206, at least one seat upgrade option is determined. In accordance with an embodiment, the at least one seat upgrade option is determined from the existing seat information and the available seat information. The at least one seat upgrade option may comprise upgraded seat number(s) and a cost associated with upgrading to the upgraded seat number(s) from the user's existing seat number(s). The cost associated with upgrading to the upgraded seat number(s) may be provided on a ticket-by-ticket basis and/or may be provided as a total amount for the upgrade. The cost associated with upgrading the seat(s) may be determined based on the cost (purchase price) of the user's existing seat(s) and the cost associated with seat(s) of the seat upgrade option. For example, a difference between the cost of the existing seat(s) and the seat(s) of the seat upgrade option may be determined; and a premium (e.g., fixed value or a percentage) may be added to the difference to determine the cost associated with upgrading. Additional service fees may also be added to the cost associated with upgrading.

At 208, the at least one seat upgrade option is provided to the portable computing device 110. In accordance with an embodiment, the at least one seat upgrade option is transmitted over the cellular network 140 to the portable computing device 110 by SMS or MMS. For example, a second text message may be sent to the portable computing device 110. The second text message may comprise upgraded seat number(s) and a cost associated with upgrading to the upgraded seat number(s) from the user's existing seat number(s). The second text message may comprise the user's existing seat number(s) to indicate in relation to the user's existing seat number(s) where the upgraded seat number(s) are located. The second text message may comprise instructions on how to upgrade the seat(s).

At 210, a selected seat upgrade is received from the portable computing device 110. In accordance with an embodiment, the selected seat upgrade is transmitted over the cellular network 140 from the portable computing device 110 by SMS or MMS. For example, the portable computing device 110 may send a third text message comprising the selected seat upgrade.

At 212, in response to receiving from the portable computing device the selected seat upgrade, the portable computing device 110 is provided with a payment mechanism for providing payment. In accordance with an embodiment, the payment mechanism is transmitted over the cellular network 140 to the portable computing device 110 by SMS or MMS. For example, a fourth text message may be sent to the portable computing device 110 comprising the payment mechanism. The payment mechanism may be a request for making payment. For example, the payment mechanism may be a link to a third-party payment processor. For example, the link may be a link to make payment with Interact™, PayPal™ and/or any other third-party payment processor. Payment may be made by credit card, debit card, etc. By way of another example, the payment mechanism may be a request to provide payment by Apple Pay™, Google Wallet™ and/or any other third-party payment processor. Other payment mechanisms are also contemplated. The payment mechanisms may be a link to a website associated with the seat upgrading system 120 for making payment or a link to a website associated with the venue ticketing system 130 for making payment. Alternatively, in some embodiments, step 212 may be omitted, for example, when the seat upgrade is received from the portable computing device 110 at step 210, a plan (e.g., a mobile phone plan) associated with the user and/or the portable computing device 110 may be charged the cost of the seat upgrade.

When payment has been made to the payment processor, the payment processor in accordance with an embodiment provides confirmation that such payment has been received.

At 214, in response to receiving payment, the portable computing device 110 is provided with confirmation for the selected seat upgrade. For example, once confirmation of payment is received, the portable computing device 110 is provided with confirmation for the selected seat upgrade. In accordance with an embodiment, the confirmation for the selected seat upgrade is transmitted over the cellular network 140 to the portable computing device 110 by SMS or MMS. For example, the portable computing device 110 may receive a fifth text message comprising the confirmation for the selected upgrade. The confirmation for the selected upgrade may comprise an new ticket(s) with the upgraded seat(s). The confirmation for the selected upgrade may comprise one or more of a barcode, QR code, a confirmation number and the like.

With additional reference to FIG. 3A, a specific and non-limiting example of a graphical representation of a user interface of the computing device 110 is shown. The graphical representation in FIG. 3A illustrates aspects of the method 200 as seen by the user of the computing device 110 in accordance with an embodiment. A first text message 302 is shown providing existing seat information in the form of text of seat numbers for two seats F6 and F7. The first message 302 is transmitted from the computing device 110 to the seat upgrading system 120 via the messaging hub 160. A second text message 304 is shown providing the seat upgrade option in the form of an image showing three different seat upgrades. The image also shows the cost associated with each seat upgrade, the user's current seats and the seat upgrade options and the user's current seats in relation to the stage. The second text message 304 is transmitted from the seat upgrading system 120 to the computing device 110 via the messaging hub 160. In this example, three different seat upgrades options are provided: option A, seats E11 and E12 for $5; option B, seats C7 and C8 for $10; and option C, seats A3 and A4 for $15. The second text message also includes the text indicating to respond with a seat selection. A third text message 306 is shown providing the selected seat upgrade in the form of text indicating that option C has been chosen. The third text message 306 is transmitted from the computing device 110 to the seat upgrading system 120 via the messaging hub 160. A fourth text message 308 is provided with a link to make payment. The fourth text message 308 is transmitted from the seat upgrading system 120 to the computing device 110 via the messaging hub 160. The link to make payment when clicked on by the user may causes a web browser of the computing device 110 to display a webpage for making payment or causes an application on the computing device 110 to open for making payment. An example screenshot of an application for making payment is shown with reference number 320. After payment has been received, a fifth text message 310 provides the confirmation for the selected upgrade. The fifth text message 310 is transmitted from the seat upgrading system 120 to the computing device 110 via the messaging hub 160. In this example, the confirmation of the selected upgrade indicates the seat numbers for the upgrade and a QR code providing ticket information. The user may then move-up to their upgraded seat(s).

In some embodiments, at 202 of FIG. 2, receiving the existing seat information from the portable computing device 110 comprises receiving the existing seat information from the messaging hub 160. The messaging hub 160 is configured for receiving the existing seat information transmitted from the portable computing device 110 by SMS or MMS and forwarding the existing seat information to the seat upgrading system 120. With addition reference to FIG. 3B, the messaging hub 160 receives the first text message 302 comprising the existing seat information 302′ and forwards the existing seat information 302′ to the seat upgrading system 120. The seat upgrading system 120 may query the messaging hub 160 at any suitable interval or irregularly to obtain the text message(s). Alternatively, the messaging hub 160 may forward the text message(s) to the seat upgrading system 120 at any suitable interval or irregularly, without the seat upgrading system 120 querying the messaging hub 160.

After receiving the existing seat information 302′, the seat upgrading system 120 may send one or more API requests to the venue ticketing system 130 in the process of obtaining the available seat information and/or determining the at least one seat upgrade option. In some embodiments, at 204 of FIG. 2, obtaining the available seat information from the venue ticketing system 130 comprises requesting from the venue ticketing system 130 the available seat information based on the existing seat information. The request may be for available seat information that meets a criteria. The criteria may be determined based on the existing seat information. For example, the criteria may be to request available seat information that is in a better seat location (e.g., closer to a stage or an area) than the existing seat information. The venue ticketing system may send a reply with the requested information.

With additional reference to FIG. 3C, in some embodiments, a first API request 352 is transmitted by the seat upgrading system 120 to the venue ticketing system 130. The first request may be for requesting purchaser information associated with the existing seat information. A first API reply 353 may be received by the seat upgrading system 120 from the venue ticketing system 130. The first API reply 353 may comprise the purchaser information. The purchaser information may be processed by the seat upgrading system 120 to determine a criteria for requesting available seat information. The purchaser information may comprise a first and last name. The first and last names may be compared to a database to determine user preferences. For example, the database may comprise past purchases by the user. The past purchase of the user may indicate the user prefers premium seating located in a best zone of the venue. The criteria may then be for available seat information that is in the best zone. A second API request 354 may be sent to the venue ticketing system 130 from the seat upgrading system 120. The second API request 354 may be for requesting the available seat information that meets the criteria. A second API reply 355 may be received by the seat upgrading system 120 from the venue ticketing system 130. The second API reply 355 may comprise the available seat information meeting the criteria.

In some embodiments, the first API request 352 for the purchaser information may be omitted. The second API request 354 may be determined based on the available seat information and/or phone number of the portable computing device 110.

In some embodiments, a database of user phone numbers is maintained. For example, after each unique user transmits a SMS or MMS message to the seat upgrading system 120, each unique user's telephone number is recorded and stored. Each phone number in the database may have the associated past seat upgrades with that phone number also stored. In some embodiments, the database of phone number may be accessed to see if a user making a request for a seat upgrade is already in the database and if so, providing seat upgrade options based on past seat upgrades and/or determining the criteria for requesting the available seat information. For example, a seat rank process may take into account the user's past seat upgrades in determining seat upgrade options. Artificial intelligence processing and/or machine learning processing may be done on the database of phone numbers and associated past seat upgrades such that the at least one seat upgrade option may be determined based on output of artificial intelligence processing of the database of phone number and associated seat upgrades.

With additional reference to FIG. 3D, an example illustrates a first dataset 382 corresponding to the available seat information. In this example, the available seat information 382 comprises available seats and the cost of each available seat. In some embodiments, at step 206, the available seat information 382 is processed with the existing seat information to determine a second dataset 384 corresponding to the seat upgrade option. In this example, the available seat information corresponds to seats F6 and F7 and the seat upgrade option 384 is determined to have seats closer to the stage than the seats F6 and F7 and at different price points (e.g., a minor price increase, a moderate price increase and a more expensive price increase). As illustrated, the second dataset 384 comprises three upgrade options and the cost of the upgrade for each seat.

In some embodiments, a seat rank is performed at 206. That is, based on the existing seat information and the available seat information, different seat upgrade options may be determined and then ranked. For example, three different seat upgrade options may be provided from more than three possible seat upgrades. The three different seat upgrade options may provide better seats than the user's existing seats. For example, the first seat upgrade option may provide seats closer to a stage than the user's existing seats, the second seat upgrade option may provide seats closer to the stage than the first seat upgrade option and the third seat upgrade option may provide seats closest to the stage. In some embodiments, price tracking may be performed to monitor any increases or decreases in ticket prices. The price tracking may be used in determining the different seat upgrade options.

In some embodiments, as illustrated in FIG. 3C, a third API request 356 is transmitted to the venue ticketing system 130 prior to providing the at least one seat upgrade option to the portable computing device at 208 of FIG. 2. The third API request 356 may be a seat hold request for requesting that the venue ticketing system 130 hold the seat(s) corresponding to the at least one seat upgrade option. The third API reply 357 may be received by the seat upgrading system 120 from the venue ticketing system 130. The third API reply 357 may comprise an acknowledgment that seat(s) corresponding to the at least one seat upgrade option are on hold. The seat(s) on hold may be on hold for a period of time (e.g., 10 minutes) and the period of time and/or an expiry time may be provided in the third API reply 357.

In some embodiments, at 208 of FIG. 2, providing the at least one seat upgrade option to the portable computing device 110 comprises providing the at least one seat upgrade option to the messaging hub 160. The messaging hub 160 is configured for providing the at least one seat upgrade option to the portable computing device 110 by SMS or MMS. As illustrated in FIG. 3B, the messaging hub 160 receives the at least one seat upgrade 304′ from the seat upgrading system 120 and transmits the second text message 304 comprising the at least one seat upgrade 304′ to the portable computing device 110.

In some embodiments, at 210 of FIG. 2, receiving the selected seat upgrade from the portable computing device 110 comprises receiving the selected seat upgrade from the messaging hub 160. The messaging hub 160 is configured for receiving the selected seat upgrade transmitted from the portable computing device 110 by SMS or MMS and forwarding the selected seat upgrade to the seat upgrading system 120. As illustrated, in FIG. 3B, messaging hub 160 receives the third text message 306 comprising the selected seat upgrade 306′ and forwards the selected seat upgrade 306′ to the seat upgrading system 120.

In some embodiments, at 212 of FIG. 2, providing the payment mechanism to the portable computing device 110 comprises providing the payment mechanism to the messaging hub 160. The messaging hub 160 is configured for providing the payment mechanism to the portable computing device 100 by SMS or MMS. As illustrated in FIG. 3B, the messaging hub 160 receives the payment mechanism 308′ from the seat upgrading system 120 and transmits the fourth text message 308 comprising the payment mechanism 308′ to the portable computing device 110.

After receiving the payment mechanism 308′, the user via the portable computing device 110 may make payment 342 to the payment processor system 170. The payment processor system 170 may send a payment confirmation 344 to the seat upgrading system 120 once payment has been made.

In some embodiments, as shown in FIG. 3C, a fourth API request 358 may be transmitted to the venue ticketing system 130 in response to receiving the payment confirmation 344. The fourth API request 358 may be a seat purchase request to indicate that at least one seat corresponding to the selected seat upgrade is to be purchased. A fourth API reply 359 may be transmitted from the venue ticketing system 130 to the seat upgrading system 120 to acknowledge the selected seat has been purchased. The fourth API reply 359 may comprise ticket information for the purchased seat, for example an electronic ticket, a confirmation number, and/or the like. This ticket information may later be forwarded by the seat upgrading system 120 to the portable computing device 110.

In some embodiments, at 214 of FIG. 2, providing the confirmation for the selected seat upgrade to the portable computing device 110 comprises providing the confirmation for the selected seat upgrade to the messaging hub 160 configured for providing the confirmation for the selected seat upgrade to the portable computing device 110 by SMS or MMS. As illustrated in FIG. 3B, the messaging hub 160 receives the confirmation for the selected seat upgrade 310′ from the seat upgrading system 120 and transmits the fifth text message 310 comprising the selected seat upgrade 310′ to the portable computing device 110. The confirmation for the selected seat upgrade may comprise the ticket information obtained from the venue ticketing system 130.

In some embodiments, as shown in FIG. 3C, a fifth API request 360 is transmitted to the venue ticketing system 130 in response to receiving the payment confirmation. The fifth API request 360 may be a seat release request indicating that at least one seat corresponding to the existing seat information is eligible for resale. A fifth API reply 361 may be transmitted from the venue ticketing system 130 to the seat upgrading system 120 acknowledging the release of the seat(s). In some embodiments, the fourth API 358 request and the fifth API request 360 may be combined into a single API request for purchase of the ticket(s) and release of the existing ticket(s).

In some embodiments, a batch processing of the payment to the venue ticketing system 130 from the seat upgrading system 120 is performed after the event at the venue is closed.

In some embodiments, cascading seat sales may be performed. For example, after a first user has upgraded his/her seat, the first user's relinquished seats may be re-sold to a second user.

In some embodiments, the seat upgrading system 120 uses artificial intelligence and/or machine learning processing to at 206 to determine the at least one seat upgrade option.

In some embodiments, the seat upgrading system 120 is integrated with the venue ticketing system 130 to comprise a single system. Accordingly, the process described herein in relation to the seat upgrading system 120 and the venue ticketing system 130 may be performed by a single system.

In accordance with an embodiment, when the seat upgrading system 120 provides any information to the messaging hub 160 to transmit to the portable computing device 110 by SMS or MMS, the seat upgrading system also provides the telephone number associated with the portable computing device 110.

It should be appreciated that the systems and method described herein may provide real-time seat upgrading to existing ticket holders. For example, users may be able to upgrade their seat location after entering a venue with their existing tickets without having to go a physical box office or ticket stand to upgrade their tickets.

With reference to FIG. 4, the seat upgrading system 120 may be implemented by a computing device. The computing device may comprise a processing unit 412 and a memory 414, which memory has stored thereon computer-executable instructions 416. The processing unit 412 may comprise any suitable devices configured to implement the system such that instructions 416, when executed by the system or other programmable apparatus, may cause the performance of various aspects of the method 200 as described herein. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412.

The methods and systems for upgrading at least one seat described herein may be implemented in a high level procedural or object oriented programming or scripting language, or a combination thereof, to communicate with or assist in the operation of a computer system. Alternatively, the methods and systems for upgrading at least one seat may be implemented in assembly or machine language. The language may be a compiled or interpreted language. Program code for implementing the methods and systems for upgrading at least one seat may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for upgrading at least one seat may also be considered to be implemented by way of a non-transitory computer-readable storage medium having a computer program stored thereon. The computer program may comprise computer-readable instructions which cause a computer, or in some embodiments the processing unit 412, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for upgrading at least one seat may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A computer-implemented method for upgrading at least one ticket, the method comprising:
receiving existing seat information from a portable computing device, the existing seat information being transmitted over a cellular network from the portable computing device by short message service or multimedia messaging service;
obtaining available seat information;
processing, with at least one processing unit, the existing seat information and the available seat information to determine at least one seat upgrade option;
providing the at least one seat upgrade option to the portable computing device, the at least one seat upgrade option being transmitted over the cellular network to the portable computing device by short message service or multimedia messaging service;
receiving a selected seat upgrade from the portable computing device, the selected seat upgrade being transmitted over the cellular network from the portable computing device by short message service or multimedia messaging service;
in response to receive the selected seat upgrade, providing a payment mechanism to the portable computing device, the payment mechanism being transmitted over the cellular network to the portable computing device by short message service or multimedia messaging service; and
in response to receiving payment, providing a confirmation for the selected seat upgrade to the portable computing device, the confirmation for the selected seat upgrade being transmitted over the cellular network to the portable computing device by short message service or multimedia messaging service.

2. The method of claim 1, wherein receiving the existing seat information from the portable computing device comprises receiving the existing seat information from a messaging hub configured for receiving the existing seat information transmitted from the portable computing device by short message service or multimedia messaging service.

3. The method of claim 2, wherein providing the at least one seat upgrade option to the portable computing device comprises providing the at least one seat upgrade option to the messaging hub configured for providing the at least one seat upgrade option to the portable computing device by short message service or multimedia messaging service.

4. The method of claim 3, wherein receiving the selected seat upgrade from the portable computing device comprises receiving the selected seat upgrade from the messaging hub configured for receiving the selected seat upgrade transmitted from the portable computing device by short message service or multimedia messaging service.

5. The method of claim 4, wherein providing the payment mechanism to the portable computing device comprises providing the payment mechanism to the messaging hub configured for providing the payment mechanism to the portable computing device by short message service or multimedia messaging service.

6. The method of claim 5, wherein providing the confirmation for the selected seat upgrade to the portable computing device comprises providing the confirmation for the selected seat upgrade to the messaging hub configured for providing the confirmation for the selected seat upgrade to the portable computing device by short message service or multimedia messaging service.

7. The method of claim 1, wherein the existing seat information is text indicating at least one seat number.

8. The method of claim 1, wherein the existing seat information is an image indicating at least one seat number.

9. The method of claim 1, wherein obtaining available seat information comprises obtaining the available seat information from a database storing the available seat information.

10. The method of claim 1, wherein obtaining available seat information comprises obtaining the available seat information from a venue ticketing system over a data network.

11. The method of claim 10, wherein obtaining the available seat information from the venue ticketing system comprises:
transmitting a first request to the venue ticketing system, the first request for requesting purchaser information associated with the existing seat information;
receiving a first response from the venue ticketing system with the purchaser information;
processing the purchaser information to determine a criteria for requesting the available seat information;
transmitting a second request to the venue ticketing system, the second request for requesting the available seat information that meets the criteria; and
receiving a second response comprising the available seat information meeting the criteria from the venue ticketing system.

12. The method of claim 10, further comprising transmitting a seat hold request to the venue ticketing system over the data network prior to providing the at least one seat upgrade option to the portable computing device, the seat hold request requesting that the venue ticketing system hold at least one seat corresponding to the at least one seat upgrade option.

13. The method of claim 10, further comprising transmitting a seat purchase request to the ticketing system over the data network in response to receiving the payment, the seat purchase request indicating that at least one seat corresponding to the selected seat upgrade is to be purchased by the user.

14. The method of claim 13, further comprising transmitting a seat release request to the ticketing system over the data network in response to receiving the payment, the seat release request indicating that at least one seat corresponding to the existing seat information is eligible for resale.

15. The method of claim 1, wherein the payment mechanism comprises a link to a third-party payment process for providing payment.

16. A system for upgrading at least one ticket, the system comprising:
at least one processing unit; and
a non-transitory computer-readable memory having stored thereon program instructions
executable by the at least one processing unit for:
receiving existing seat information from a portable computing device, the existing seat information being transmitted over a cellular network from the portable computing device by short message service or multimedia messaging service;
obtaining available seat information from a venue ticketing system over a data network;
processing the existing seat information and the available seat information to determine at least one seat upgrade option;
providing the at least one seat upgrade option to the portable computing device, the at least one seat upgrade option being transmitted over the cellular network to the portable computing device by short message service or multimedia messaging service;
receiving a selected seat upgrade from the portable computing device, the selected seat upgrade being transmitted over the cellular network from the portable computing device by short message service or multimedia messaging service;
in response to receive the selected seat upgrade, providing a payment mechanism to the portable computing device, the payment mechanism being transmitted over the cellular network to the portable computing device by short message service or multimedia messaging service; and
in response to receiving payment, providing a confirmation for the selected seat upgrade to the portable computing device, the confirmation for the selected seat upgrade being transmitted over the cellular network to the portable computing device by short message service or multimedia messaging service.

17. The system of claim 16, wherein obtaining available seat information comprises obtaining the available seat information from a database storing the available seat information.

18. The system of claim 16, wherein obtaining available seat information comprises obtaining the available seat information from a venue ticketing system over a data network.

19. The system of claim 18, wherein obtaining the available seat information from the venue ticketing system comprises:
transmitting a first request to the venue ticketing system, the first request for requesting purchaser information associated with the existing seat information;
receiving a first response from the venue ticketing system with the purchaser information;
processing the purchaser information to determine a criteria for requesting the available seat information;
transmitting a second request to the venue ticketing system, the second request for requesting the available seat information that meets the criteria; and
receiving a second response comprising the available seat information meeting the criteria from the venue ticketing system.

20. The system of claim 18, wherein the program instructions are further executable by the at least one processing unit for transmitting a seat hold request to the venue ticketing system over the data network prior to providing the at least one seat upgrade option to the portable computing device, the seat hold request requesting that the venue ticketing system hold at least one seat corresponding to the at least one seat upgrade option.

21. (canceled)

22. (canceled)
